(19) United States
(12) Patent Application Publication
(10) Pub. No.: US 2025/0139627 A1
(43) Pub. Date: May 1, 2025

(54) SYSTEMS AND METHODS FOR OFFLINE PROCESSING OF BIOMETRICALLY-ENABLED PAYMENT TRANSACTIONS

(71) Applicant: JPMORGAN CHASE BANK, N.A., New York, NY (US)

(72) Inventors: Ashok SINGAL, Henderson, NV (US); Timothy KLOS, Chicago, IL (US); Prashant SHARMA, Madison, NJ (US); Carleigh WATTS, Brooklyn, NY (US)

(21) Appl. No.: 18/499,019

(22) Filed: Oct. 31, 2023

(51) Int. Cl. G06Q 20/40; G06Q 20/32

(52) U.S. Cl. CPC G06Q 20/40145; G06Q 20/3274

(57) ABSTRACT

Offline processing of biometrically-enabled payment transactions are disclosed. A method may include a biometric processor computer program: receiving a biometric payment request from a user electronic device comprising transaction information for a transaction at a payment terminal for a merchant that does not have an active connection with the biometric processor computer program or with an acquirer for the merchant; receiving, from the user electronic device, a user biometric; retrieving a financial instrument associated with the user biometric; providing the financial instrument and the transaction information to the acquirer that decisions the transaction and returns an approval for the transaction; and returning the approval and the financial instrument to the user electronic device. The user electronic device generates a code comprising the financial instrument and the approval and presents the code to the payment terminal, and the payment terminal processes the transaction as an offline approval.

### BACKGROUND OF THE INVENTION

### 1. Field of the Invention

Embodiments relate to systems and methods for offline processing of biometrically-enabled payment transactions.

### 2. Description of the Related Art

Traditional methods of payments with cards or digital wallets support a “store and forward model.” For example, if a payment terminal is offline, the payment terminal stores a transaction token until the Internet connection is resumed. At that point, the payment terminal forwards the tokens for processing and settlement.

The use of biometric payments at payment terminals is an emerging technology. The payment terminal, however, must be on-line to verify a customer's biometrics, so the store and forward model cannot be used. Thus, payments will fail when the payment terminal is offline.

### SUMMARY OF THE INVENTION

Systems and methods for offline processing of biometrically-enabled payment transactions are disclosed. According to an embodiment, a method for offline processing of biometrically-enabled payment transactions may include: (1) receiving, by a biometric processor computer program, a biometric payment request from a user electronic device comprising transaction information for a transaction at a payment terminal for a merchant, wherein the payment terminal does not have an active connection with the biometric processor computer program or with an acquirer for the merchant; (2) receiving, by the biometric processor computer program and from the user electronic device, a user biometric; (3) retrieving, by the biometric processor computer program, a financial instrument associated with the user biometric; (4) providing, by the biometric processor computer program, the financial instrument and the transaction information to the acquirer, wherein the acquirer may be configured to decision the transaction and return an approval for the transaction to the biometric processor computer program; and (5) returning, by the biometric processor computer program, the approval and the financial instrument to the user electronic device. The user electronic device may be configured to generate a code comprising the financial instrument and the approval and present the code to the payment terminal, and the payment terminal may be configured to process the transaction as an offline approval.

In one embodiment, the user biometric may include a finger biometric, a face biometric, a palm biometric and/or a voice biometric.

In one embodiment, the user biometric may also include images, images, vectors, and/or datapoints.

In one embodiment, the financial instrument may include a payment token.

In one embodiment, the code may include a QR code or a radio frequency code.

In one embodiment, the payment terminal may be configured to provide the financial instrument and the transaction information to the acquirer after the active connection is restored.

In one embodiment, the method may also include receiving, by the biometric processor computer program, the user biometric and a financial instrument from the user electronic device and storing, by the biometric processor computer program, an association between the user biometric and the financial instrument.

According to another embodiment, a method for offline processing of biometrically-enabled payment transactions may include: (1) sending, by a biometric payment application executed by a user electronic device and to a payment terminal for a merchant, a biometric payment request for a transaction; (2) receiving, by the biometric payment application and from the payment terminal, a first code comprising a uniform resource locator for a biometric payment processor and transaction information for the transaction, wherein the payment terminal does not have an active connection with a biometric processor or with an acquirer for the merchant; (3) accessing, by the biometric payment application, the uniform resource locator; (4) collecting, by the biometric payment application, a user biometric; (5) communicating, by the biometric payment application, the user biometric and the transaction information to the biometric payment processor; (6) receiving, by the biometric payment application, approval information for the transaction comprising a payment token from the biometric payment processor or from the acquirer; (7) generating, by the biometric payment application, a second code comprising the approval information; and (8) communicating, by the biometric payment application, the second code to the payment terminal. The payment terminal may be configured to process the transaction using the approval information as an offline approval.

In one embodiment, the user biometric may include a finger biometric, a face biometric, a palm biometric and/or a voice biometric.

In one embodiment, the user biometric may also include images, images, vectors, and/or datapoints.

In one embodiment, the first code and the second code comprise a QR code or a radio frequency code.

In one embodiment, the first code may also include information for a payment authorization request.

In one embodiment, the approval information may include a payment token.

In one embodiment, the payment terminal may be configured to provide the payment token and the transaction information to the acquirer after an active connection is restored.

In one embodiment, the method may also include registering, by the biometric payment application, a financial instrument and the user biometric with the biometric payment processor. The biometric payment processor may be configured to generate a payment token for the financial instrument and to associate the payment token with the user biometric.

According to another embodiment, a method for offline processing of biometrically-enabled payment transactions may include: (1) registering, by a biometric payment application executed by a user electronic device, a financial instrument and a user biometric with a biometric payment processor; (2) receiving, by the biometric payment application and from the biometric payment processor, a payment token for the financial instrument; (3) storing, by the biometric payment application, the payment token in secure storage on the user electronic device; (4) sending, by the biometric payment application executed by a user electronic device and to a payment terminal for a merchant, a biometric payment request for a transaction; (5) receiving, by the biometric payment application and from the payment terminal, a first code comprising a uniform resource locator for a biometric payment processor and a transaction amount for the transaction, wherein the payment terminal does not have an active connection with a biometric processor or with an acquirer for the merchant; (6) determining, by the biometric payment application, that a connection between the biometric payment application and the biometric payment processor is unavailable; (7) comparing, by the biometric payment application, the transaction amount to a transaction threshold; (8) generating, by the biometric payment application, a second code comprising the payment token in response to the transaction amount being at or below the transaction threshold; and (9) communicating, by the biometric payment application, the second code to the payment terminal. The payment terminal may be configured to process the transaction as an offline approval.

In one embodiment, the user biometric may include a finger biometric, a face biometric, a palm biometric and/or a voice biometric.

In one embodiment, the user biometric may also include images, images, vectors, and/or datapoints.

In one embodiment, the first code and the second code comprise a QR code or a radio frequency code.

In one embodiment, the first code may also include information for a payment authorization request.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for offline processing of biometrically-enabled payment transactions according to an embodiment;

FIG. 2 illustrates a method for user onboarding for offline processing of biometrically-enabled payment transactions according to an embodiment;

FIGS. 3A and 3B illustrates a method for offline processing of biometrically-enabled payment transactions according to an embodiment; and

FIG. 4 depicts an exemplary computing system for implementing aspects of the present disclosure.

### DETAILED DESCRIPTION OF PREFERRED EMBODIMENTS

Embodiments relate to systems and methods for offline processing of biometrically-enabled payment transactions.

For example, in one embodiment, a user may approach a payment terminal and may select a suitable biometric payment option (e.g., Pay by Face, Pay by Palm, Pay by Voice, etc.). The payment terminal may recognize that it does not have a connection to a biometric processor, and may present a code, such as a machine readable code (e.g., QR code, bar code, etc.) for the user to scan, or a radio frequency code (e.g., near field communication (NFC), Bluetooth Low Energy (BLE), etc.) for the user electronic device.

The user's electronic device, which is connected to the Internet, receives the code which directs the user electronic device to a uniform resource locator (URL) for a biometric processor. The user electronic device then captures a user biometric, such as a fingerprint, palm scan, face scan, voice, etc.

After the biometric processor validates the biometric, the biometric processor retrieves a payment token and may provide the payment token to the user electronic device. The biometric processor may provide the payment token with the transaction information to the acquirer, which may receive approval for the transaction from the issuer via the card associations and networks.

The acquirer may inform the biometric processor of the approval, and may also provide the payment token and an approval code to the biometric processor. The acquirer may return the payment token to the merchant so the transaction can be submitted for settlement off-line.

After receiving the payment token, the payment terminal proceeds with the normal payment process. If the payment terminal still does not have an Internet connection, it can use the store and forward model, and forward the secure token to the acquirer for payment once the connection is re-established.

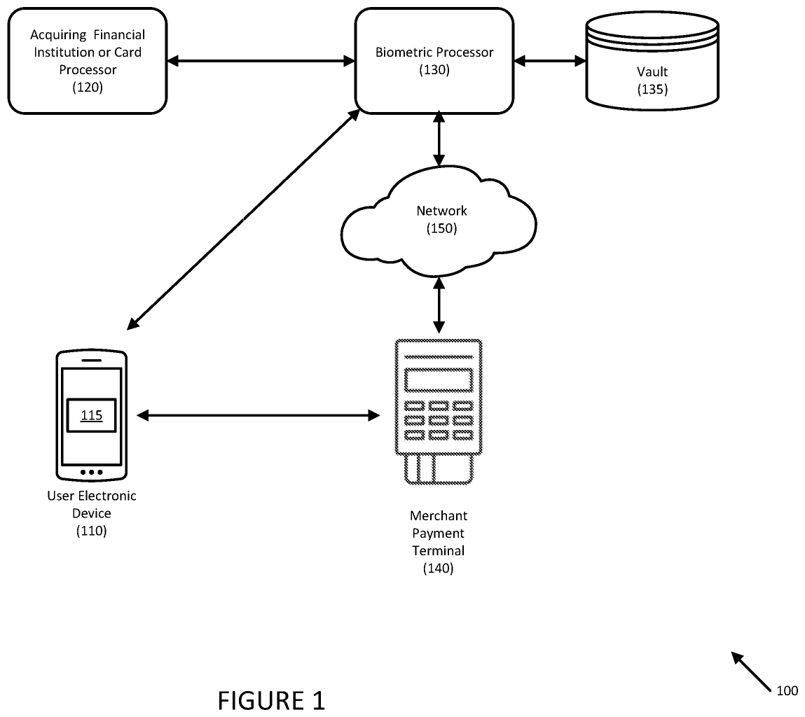

Referring to FIG. 1, a system for offline processing of biometrically-enabled payment transactions is disclosed according to an embodiment. System 100 may include user electronic device 110, which may be any suitable mobile electronic device, including computers (e.g., notebooks, laptops, tablets, etc.), smart devices (e.g., smartphones, smart watches, etc.), Internet of Things (IoT) appliances, etc. User electronic device 110 may execute computer program 115, which may be a payment application, a browser, etc.

System 100 may also include acquiring financial institution 120, which may also be a card processor. Issuing financial institution 120 may interface with biometric processor 130, which may provide biometric verification services for acquiring financial institution 120. It may further maintain a mapping of user biometrics to financial instruments in vault 135.

System 100 may further include merchant payment terminal 140, which may be a biometric payment-enabled payment terminal. Merchant payment terminal 140 may include, for example, an image capture device (e.g., a camera, not shown), a display (not shown), a biometric sensor (not shown), a RF transceiver (not shown), etc.

Examples of payment terminals 140 include point of sale devices, kiosks, mobile devices, etc.

Merchant payment terminal 140 may communicate with biometric processor 130 via network 150, which may be the Internet.

User electronic device 110 may communicate with biometric processor 130 via network 150 and/or a second network (not shown), such as a cellular network.

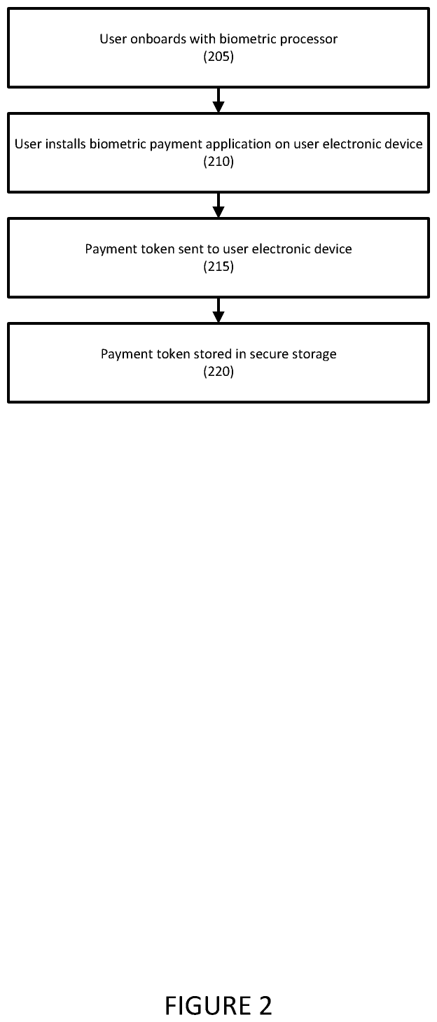

Referring to FIG. 2, a method for user onboarding for offline processing of biometrically-enabled payment transactions is disclosed according to an embodiment.

In step 205, a user may onboard with a biometric processor. For example, the user may present a financial instrument, such as a credit card, a debit card, etc. and may register one or more biometrics with the biometric processor. Examples of biometrics may include fingerprints, palmprints, facial biometrics, voice biometrics, etc.

The biometric processor may associate the biometric(s) with the financial instrument and may store the association in, for example, a vault.

In step 210, the user may install a biometric payment application on the user electronic device. The biometric payment application may be provided by the biometric processor.

In another embodiment, the user may access the biometric processor using a browser.

Once onboarded, in step 215, the biometric processor may send a payment token for the financial instrument to the user electronic device. In step 220, the user electronic device may store the payment token in secure storage on the user electronic device.

In one embodiment, the payment token may be used for transactions in which neither the payment terminal for the merchant nor the user electronic device has an Internet connection with the biometric processor and the acquirer.

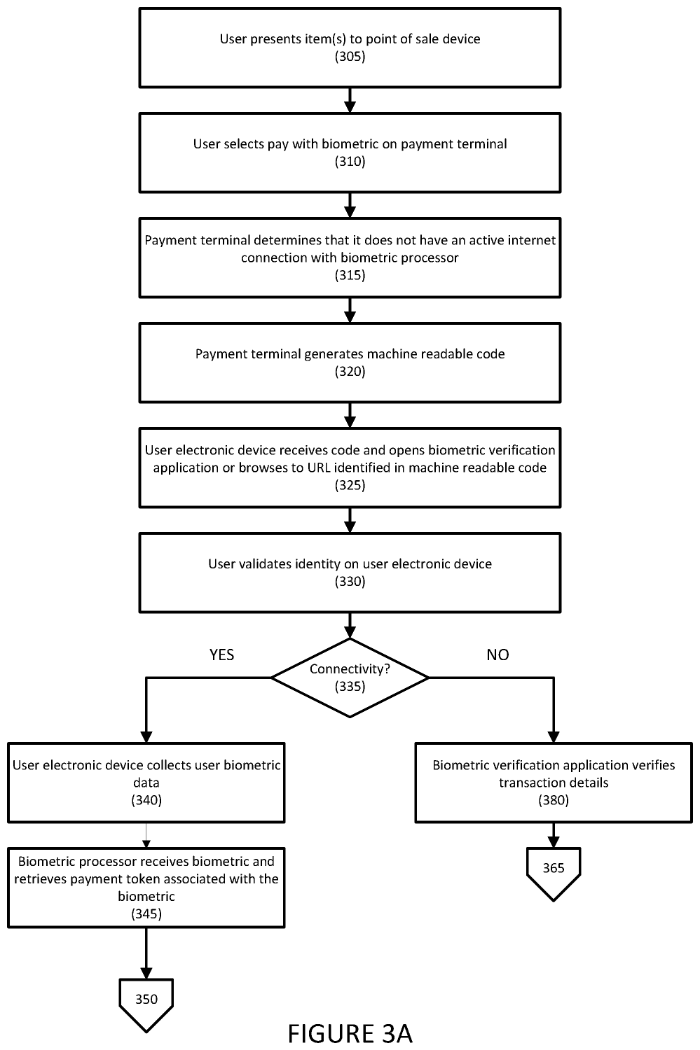

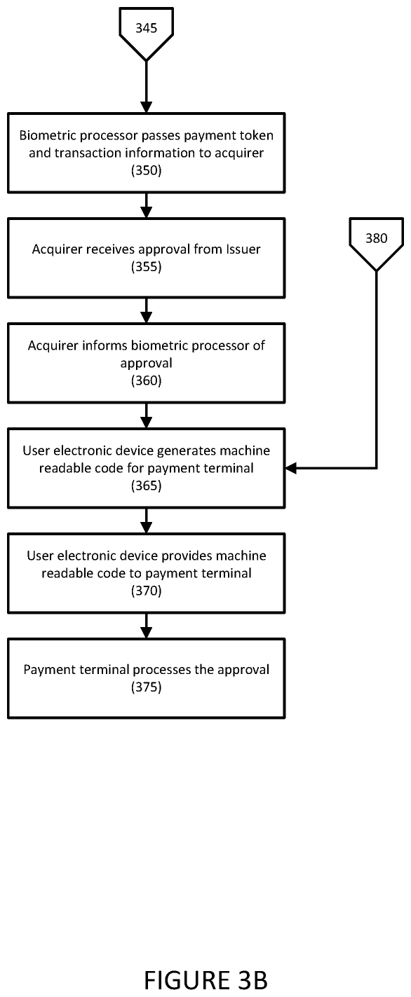

Referring to FIGS. 3A and 3B, a method for offline processing of biometrically-enabled payment transactions is disclosed according to an embodiment. In embodiments, the process of FIGS. 3A and 3B may follow the process of FIG. 2.

In step 305, the user may present a good or a service to a payment terminal for purchase, and in step 310, the user may select a pay with biometric option on the payment terminal.

In step 315, the payment terminal may determine that it does not have an active Internet connection with the biometric processor that supports the pay with biometric feature or with an acquirer for the merchant.

In step 320, the payment terminal may generate a code, such as a machine readable code, a RF code, etc. Examples of codes include a bar code, a QR code, a RF code, etc. The code may identify the merchant, the payment terminal, and may include transaction information (e.g., items, cost, tax, etc.). In one embodiment, the code may include information that is typically included in a payment authorization request from the payment terminal.

The code may also include a URL for the biometric processor.

In step 325, the user electronic device may receive the code and may open a biometric verification application on the user electronic device, if installed. Alternatively, a browser may navigate to the URL that is included in the code.

In step 330, the user may validate its identity to the user electronic device (e.g., the operating system, the biometric verification application, etc.). For example, the user electronic device, the biometric verification application, etc. may require the user to enter a username, a password, a biometric, etc. for local authentication.

In step 335, if the user electronic device has connectivity with the biometric processor, in step 340, the user electronic device may collect a biometric from the user. For example, the user electronic device may collect images, vectors, datapoints, etc. for the biometric using the user electronic device's camera, touchscreen, microphone, etc. It may then send the biometric data to the biometric processor. It may also provide the transaction information to the biometric payment processor.

In step 345, the biometric processor may retrieve a payment token that is mapped to the biometric. In step 350, the biometric processor may provide the payment token with the transaction information to the acquirer.

In step 355, the acquirer may receive approval for the transaction from the issuer via the card associations and networks.

In step 360, the acquirer may inform the biometric processor of the approval. It may also provide the payment token, expiration date, cardholder name, card entry method (e.g., biometric/cardholder initiated payment (CIP)), and an approval code to the biometric processor. The acquirer may return the payment token to the merchant so the transaction can be submitted for settlement off-line.

The acquirer or the biometric processor may provide the user electronic device with some or all of the same information.

In step 365, the user electronic device may generate a code for the payment terminal based on the information received from the acquirer or the biometric processor. The code may be a bar code, a QR code, a RF code, etc., and may include the payment token, the expiration date, the cardholder name, the card entry method (e.g., biometric/CIP), and the approval code.

In step 370, the user electronic device may provide the code to the payment terminal by, for example, displaying the code on a screen (e.g., a QR code), communicating the code by radio frequency communication (e.g., NFC, BLE, etc.), etc. In one embodiment, the payment terminal receives the code and may extract the payment token. From there, the payment terminal may treat the transaction as an offline approval and may store the payment token until the Internet connection is restored.

Once the payment terminal's Internet connection with the acquirer is restored, in step 375, the payment terminal may process the approval. Because the transaction amount is already approved with an authorization code, it would proceed to settlement and would not need further approval.

If, in step 335, the user electronic device does not have connectivity to the biometric processor, in step 380, the biometric verification application may verify the transaction details. For example, the biometric verification application may compare the transaction amount to a threshold, and if the transaction amount is below the threshold, in step 365, may generate the code for the payment terminal, including the payment token that is stored in secure storage. The code may be a bar code, a QR code, a RF code, etc., and may include the payment token, the expiration date, the cardholder name, the card entry method (e.g., biometric/CIP), and the approval code.

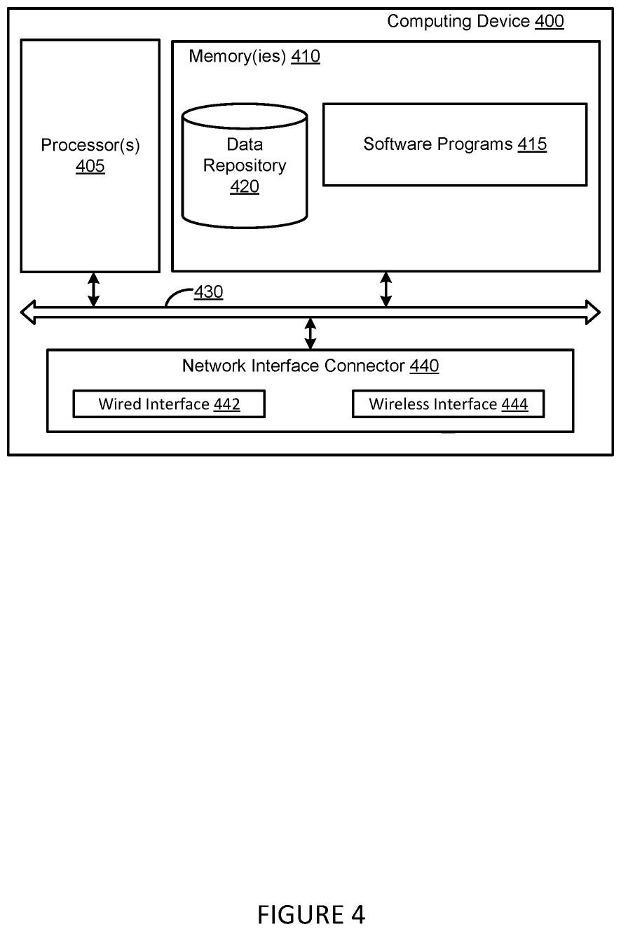

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for offline processing of biometrically-enabled payment transactions, comprising:
receiving, by a biometric processor computer program, a biometric payment request from a user electronic device comprising transaction information for a transaction at a payment terminal for a merchant, wherein the payment terminal does not have an active connection with the biometric processor computer program or with an acquirer for the merchant;
receiving, by the biometric processor computer program and from the user electronic device, a user biometric;
retrieving, by the biometric processor computer program, a financial instrument associated with the user biometric;
providing, by the biometric processor computer program, the financial instrument and the transaction information to the acquirer, wherein the acquirer is configured to decision the transaction and return an approval for the transaction to the biometric processor computer program; and
returning, by the biometric processor computer program, the approval and the financial instrument to the user electronic device, wherein the user electronic device is configured to generate a code comprising the financial instrument and the approval and present the code to the payment terminal, and the payment terminal is configured to process the transaction as an offline approval.

2. The method of claim 1, wherein the user biometric comprises a finger biometric, a face biometric, a palm biometric and/or a voice biometric.

3. The method of claim 2, wherein the user biometric further comprises images, images, vectors, and/or datapoints.

4. The method of claim 1, wherein the financial instrument comprises a payment token.

5. The method of claim 1, wherein the code comprises a QR code or a radio frequency code.

6. The method of claim 1, wherein the payment terminal is configured to provide the financial instrument and the transaction information to the acquirer after the active connection is restored.

7. The method of claim 1, further comprising:
receiving, by the biometric processor computer program, the user biometric and a financial instrument from the user electronic device; and
storing, by the biometric processor computer program, an association between the user biometric and the financial instrument.

8. A method for offline processing of biometrically-enabled payment transactions, comprising:
sending, by a biometric payment application executed by a user electronic device and to a payment terminal for a merchant, a biometric payment request for a transaction;
receiving, by the biometric payment application and from the payment terminal, a first code comprising a uniform resource locator for a biometric payment processor and transaction information for the transaction, wherein the payment terminal does not have an active connection with a biometric processor or with an acquirer for the merchant;
accessing, by the biometric payment application, the uniform resource locator;
collecting, by the biometric payment application, a user biometric;
communicating, by the biometric payment application, the user biometric and the transaction information to the biometric payment processor;
receiving, by the biometric payment application, approval information for the transaction comprising a payment token from the biometric payment processor or from the acquirer;
generating, by the biometric payment application, a second code comprising the approval information; and
communicating, by the biometric payment application, the second code to the payment terminal;
wherein the payment terminal is configured to process the transaction using the approval information as an offline approval.

9. The method of claim 8, wherein the user biometric comprises a finger biometric, a face biometric, a palm biometric and/or a voice biometric.

10. The method of claim 9, wherein the user biometric further comprises images, images, vectors, and/or datapoints.

11. The method of claim 8, wherein the first code and the second code comprise a QR code or a radio frequency code.

12. The method of claim 8, wherein the first code further comprises information for a payment authorization request.

13. The method of claim 8, wherein the approval information comprises a payment token.

14. The method of claim 8, wherein the payment terminal is configured to provide the payment token and the transaction information to the acquirer after an active connection is restored.

15. The method of claim 8, further comprising:
registering, by the biometric payment application, a financial instrument and the user biometric with the biometric payment processor;
wherein the biometric payment processor is configured to generate a payment token for the financial instrument and to associate the payment token with the user biometric.

16. A method for offline processing of biometrically-enabled payment transactions, comprising:
registering, by a biometric payment application executed by a user electronic device, a financial instrument and a user biometric with a biometric payment processor;
receiving, by the biometric payment application and from the biometric payment processor, a payment token for the financial instrument;
storing, by the biometric payment application, the payment token in secure storage on the user electronic device;
sending, by the biometric payment application executed by a user electronic device and to a payment terminal for a merchant, a biometric payment request for a transaction;
receiving, by the biometric payment application and from the payment terminal, a first code comprising a uniform resource locator for a biometric payment processor and a transaction amount for the transaction, wherein the payment terminal does not have an active connection with a biometric processor or with an acquirer for the merchant;
determining, by the biometric payment application, that a connection between the biometric payment application and the biometric payment processor is unavailable;
comparing, by the biometric payment application, the transaction amount to a transaction threshold;
generating, by the biometric payment application, a second code comprising the payment token in response to the transaction amount being at or below the transaction threshold; and
communicating, by the biometric payment application, the second code to the payment terminal;
wherein the payment terminal is configured to process the transaction as an offline approval.

17. The method of claim 16, wherein the user biometric comprises a finger biometric, a face biometric, a palm biometric and/or a voice biometric.

18. The method of claim 17, wherein the user biometric further comprises images, images, vectors, and/or datapoints.

19. The method of claim 17, wherein the first code and the second code comprise a QR code or a radio frequency code.

20. The method of claim 17, wherein the first code further comprises information for a payment authorization request.
